(19) United States
(12) Patent Application Publication
(10) Pub. No.: US 2013/0008971 A1
(43) Pub. Date: Jan. 10, 2013

(54) AIR CONDITIONING APPARATUS WITH A FOOT VENT

(75) Inventors: Gerald Richter, Aachen (DE); Juergen Hoppen, Koeln (DE); Raymond Ambs, Wegberg (DE)

(73) Assignee: VISTEON GLOBAL TECHNOLOGIES, INC., Van Buren Twp, MI (US)

(21) Appl. No.: 13/540,854

(22) Filed: Jul. 3, 2012

(30) Foreign Application Priority Data
Jul. 4, 2011 (DE) 10 2011 051 544.5

(51) Int. Cl. B60H 1/24; B60H 1/00

(52) U.S. Cl. 237/28; 454/143

(57) ABSTRACT

An air conditioning apparatus for a ventilation, heating, and air conditioning of an interior of a vehicle with a foot vent, in which a shape of the foot vent is substantially rectangular with a dimension of the rectangular shape in a direction of travel of the vehicle larger than a dimension of the rectangular shape transverse to the direction of travel of the vehicle, the rectangular shape optimizing an installation space, an efficiency, and acoustics of the air conditioning apparatus.

### CROSS-REFERENCE TO RELATED APPLICATION

This application claims the benefit of German Patent Application No. DE 10 2011 051 544.5 filed Jul. 4, 2011, the entire disclosure of which is hereby incorporated herein by reference.

### FIELD OF THE INVENTION

The invention relates to an air conditioning apparatus with a foot vent, wherein disadvantages in terms of acoustics and flow technology can be prevented.

### BACKGROUND OF THE INVENTION

Air conditioning apparatuses with a foot vent for motor vehicles are usually arranged between the engine space and the dashboard. The air, which is conveyed by a blower, and which is suctioned from outside of the vehicle interior during normal operation, and from the vehicle interior during ambient air operation, flows through the air conditioning apparatus in which it is cooled, dehumidified, and heated as needed. The air that has been processed in this manner flows out of the air conditioning apparatus through air vents, and from said vents it reaches the air outlets for the defroster, the interior, and the foot space.

The outlets for the foot space are generally arranged to the side of the air conditioning apparatus, and their design is usually square. In systems with small installation height, due to the design of the dashboards and their respective arrangement, a square design of the outlets for the foot space is still usually used, so that small cross sections of the exit surface and resulting high air speeds in the case of corresponding blower stages lead to disadvantages in terms of acoustics and flow technology.

U.S. Pat. Appl. Pub. No. 2007/0281600 A1 discloses an air conditioning unit for motor vehicles which has an air distribution system in which air ducts are provided. The air current in the air ducts, preferably in the higher blower stages, generates predominantly low-frequency sound. Constrictions are provided in the air ducts, in order to dampen the generated sound waves, and to prevent self-resonance oscillations.

DE 100 25 083 A1 discloses an air conditioning unit which comprises an evaporator for the coolant, a radiator, and an electrical heating element. By means of control flaps, the air flowing through the air conditioning unit is guided and led to the radiators, or led completely or partially past said radiators. Again, by means of control flaps, the air that has been processed in this manner is subsequently directed to the individual air vents (defroster, interior, and foot space). Measures to prevent disadvantages in terms of acoustics and flow technology are not provided in this document.

DE 198 54 940 A1 discloses a component assembly for a cockpit of a motor vehicle in which a plurality of devices can be incorporated. This has consequences for the construction of the air conditioning unit located behind the cockpit. The air conditioning unit has air vents for the rear area, the foot space, the interior, and the defroster. In this patent specification as well, no measures are provided to prevent disadvantages in terms of acoustics and flow technology.

Finally, DE 10 2005 021 520 A1 discloses an air conditioning unit for use in a vehicle, in which it is possible, by means of switching possibilities provided in the air conditioning unit, to direct air currents that are at different temperatures to the individual areas, for example, back seat outlets. This document as well contains no measures used to prevent disadvantages in terms of acoustics and flow technology.

Therefore, it is desirable to make available a foot outlet with an appropriate cross section, by means of which disadvantages in terms of acoustics and flow technology can be prevented, even in air conditioning apparatuses having a small installation height, and even at high air throughputs.

### SUMMARY OF THE INVENTION

Consistent and consonant with the present invention, a foot outlet with an appropriate cross section, by means of which disadvantages in terms of acoustics and flow technology can be prevented, even in air conditioning apparatuses having a small installation height, and even at high air throughputs, has surprisingly been discovered.

To solve this problem, an air conditioning apparatus with a foot vent is proposed, apparatus which has the characteristics of claim 1. Additional advantageous embodiments of the subject matter of the invention are indicated in the remaining claims.

The essential aspect of the invention is the idea of still providing a sufficient cross section for the foot outlet, while nevertheless making possible a compact air conditioning apparatus that is also suitable for installation in small cockpits, wherein the foot outlet is arranged close to the heater core. This is achieved by the fact that the foot outlet has a clearly larger dimension in the X direction, that is in the longitudinal direction or travel direction of the vehicle, than in the Z direction. The outlet itself can be arranged in the angular range of ±30° deviation from the horizontal. It has been found that a ratio of extent in the X direction to extent in the Z direction of at least 2:1 provides favorable results.

Special advantages that can be achieved with the invention consist of the installation space advantage, particularly in the Z direction, the efficiency, as well as the acoustics.

### BRIEF DESCRIPTION OF THE DRAWINGS

Advantages and uses can be obtained from the following description in reference to the drawings.

FIG. 1 is a perspective view of an air conditioning apparatus of the prior art with an approximately square foot vent.

FIG. 2 is a side lavational view of an embodiment of the invention with foot vent enlarged in the X direction.

FIG. 3 is a perspective view of an air conditioning apparatus with enlarged foot vent, viewed from the passenger space.

FIG. 4 is a perspective view of an air conditioning apparatus with enlarged foot vent, viewed from the engine space.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

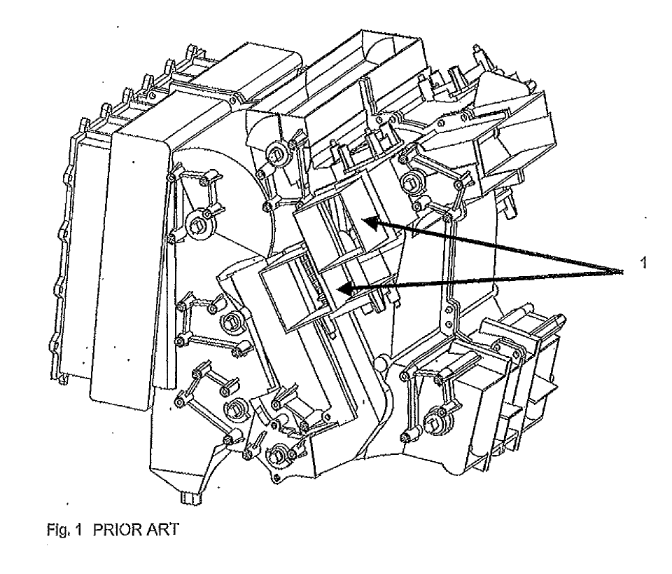

In FIG. 1, an air conditioning apparatus in an oblique representation is shown, in which the heat exchangers—not shown in further detail—and the flaps required for controlling the air currents are provided. The foot vents 1 are provided close to the heater core and they have the usual approximately square cross section.

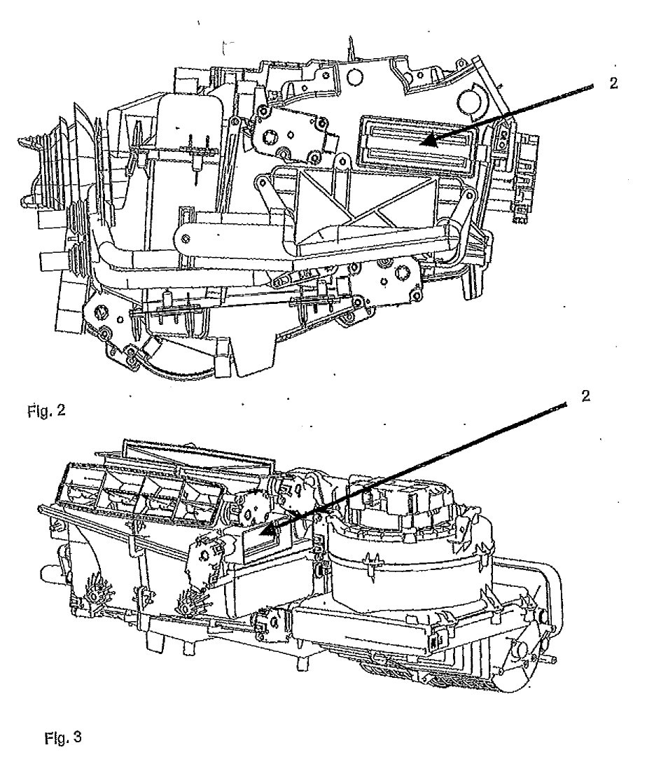

In FIG. 2, a first embodiment of the invention in a side view is shown, wherein the heat exchangers and the control flaps are represented diagrammatically. Close to the heater core located in the housing, the foot vent 2 is shown, which, according to the invention, has an approximately rectangular shape and a ratio of extent in the X direction and Z direction of 2:1. The air conditioning apparatus has a relatively flat design, so that it is adapted to a cockpit architecture with small installation space.

In FIG. 3, a representation of the air conditioning unit, viewed from the passenger space, can be seen in assembled form, where the foot outlets 2 have the shape according to the invention. The foot outlets 2 are located to the side beneath the vents for the vehicle interior and the defroster. The air conditioning apparatus is constructed relatively flat, so that it can be installed even in cockpit architectures with small installation space.

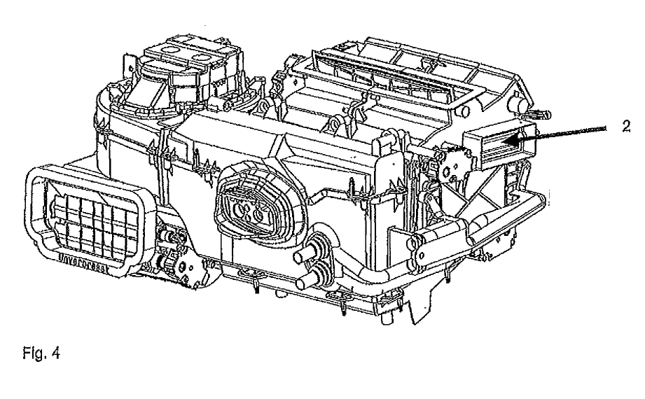

In FIG. 4, a representation of the air conditioning unit, viewed from the engine space, can be seen in assembled form, where the foot outlet 2 has the shape according to the invention. The air inlet, the blower, and the feed and removal lines for the cooling water and the coolant can be seen on the housing. The foot vent 2 is located to the side beneath the vents for the defroster and the vehicle interior.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An air conditioning apparatus comprising:
a foot outlet of a ventilation, heating, and air conditioning system for an interior of a vehicle, wherein the foot outlet has a substantially rectangular cross section, and wherein a dimension of the cross section in an X direction taken in a direction of travel of the vehicle is greater than a dimension of the cross section in a Z direction taken transverse to the direction of travel of the vehicle.

2. The air conditioning apparatus according to claim 1, wherein a ratio of the dimension of the cross section in the X direction to the dimension of the cross section in the Z direction is about 2:1.

3. The air conditioning apparatus according to claim 1, wherein a ratio of the dimension of the cross section in the X direction to the dimension of the cross section in the Z direction is optimized with regard to efficiency, particularly pressure loss.

4. The air conditioning apparatus according to claim 1, wherein a ratio of the dimension of the cross section in the X direction to the dimension of the cross section in the Z direction is optimized with regard to acoustics, particularly with regard to noises generated by the air current.

5. The air conditioning apparatus according to claim 1, wherein the dimension of the cross section in the X direction is rotated in an angular range of about −30° with respect to horizontal.

6. The air conditioning apparatus according to claim 1, wherein the dimension of the cross section in the X direction is rotated in an angular range of about +30° with respect to horizontal.

7. The air conditioning apparatus according to claim 1, wherein the foot outlet is arranged adjacent a heater core.

8. The air conditioning apparatus according to claim 1, wherein the substantially rectangular cross section of the foot outlet facilitates minimizing a size of the air conditioning apparatus.

9. An air conditioning apparatus comprising:
a foot outlet of a ventilation, heating, and air conditioning system for an interior of a vehicle, wherein the foot outlet has a substantially rectangular cross section, and wherein a ratio of a dimension of the cross section in an X direction taken in a direction of travel of the vehicle to a dimension of the cross section in a Z direction taken transverse to the direction of travel of the vehicle is about 2:1.

10. The air conditioning apparatus according to claim 9, wherein the dimension of the cross section in the X direction is rotated in an angular range of about −30° with respect to horizontal.

11. The air conditioning apparatus according to claim 9, wherein the dimension of the cross section in the X direction is rotated in an angular range of about +30° with respect to horizontal.

12. The air conditioning apparatus according to claim 9, wherein the foot outlet is arranged adjacent a heater core.

13. The air conditioning apparatus according to claim 9, wherein the substantially rectangular cross section of the foot outlet facilitates minimizing a size of the air conditioning apparatus.

14. An air conditioning apparatus comprising:
a foot outlet of a ventilation, heating, and air conditioning system for an interior of a vehicle, wherein air from outside of the interior of the vehicle can be processed during normal operation and air from the interior of the vehicle can be processed during ambient air operation and subsequently returned to the vehicle interior, and wherein the foot outlet has a substantially rectangular cross section, and wherein a ratio of a dimension of the cross section in an X direction taken in a direction of travel of the vehicle to a dimension of the cross section in a Z direction taken transverse to the direction of travel of the vehicle is about 2:1 and the dimension of the cross section in the X direction is rotated with respect to horizontal.

15. The air conditioning apparatus according to claim 14, wherein the dimension of the cross section in the X direction is rotated in an angular range of about −30° with respect to horizontal.

16. The air conditioning apparatus according to claim 14, wherein the dimension of the cross section in the X direction is rotated in an angular range of about +30° with respect to horizontal.

17. The air conditioning apparatus according to claim 14, wherein the foot outlet is arranged adjacent a heater core.

18. The air conditioning apparatus according to claim 14, wherein the substantially rectangular cross section of the foot outlet facilitates minimizing a size of the air conditioning apparatus.
